(19) United States
(12) Patent Application Publication
(10) Pub. No.: US 2004/0179592 A1
(43) Pub. Date: Sep. 16, 2004

(54) Image coding apparatus

(75) Inventors: Tetsuya Matsumura, Tokyo (JP); Satoshi Kumaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/670,324

(22) Filed: Sep. 26, 2003

(30) Foreign Application Priority Data
Mar. 6, 2003 (JP) 2003-059795

(51) Int. Cl. H04N 7/12

(52) U.S. Cl. 375/240.01

(57) ABSTRACT

A coding parameter obtained by a first coding processing is transferred from signal processing sections (403) to (406) to a parameter input/output section (408) through a coding control section (407), and the parameter input/output section (408) stores the coding parameter in an external DRAM (411) through an SDRAM interface section (410). In a second coding processing, the coding parameter stored in the external DRAM (411) is transferred to the parameter input/output section (408) through the external DRAM (411), and the parameter input/output section (408) gives the acquired coding parameter to the signal processing sections (403) to (406) through the coding control section (407).

### BACKGROUND OF THE INVENTION

1. Field of the Invention

The present invention relates to an image coding apparatus and more particularly to an image coding apparatus for coding a dynamic image.

2. Description of the Background Art

An MPEG2 standard to be an international standard for image compression has been used for a digital AV apparatus such as a rerecording type DVD, a D-VHS or a digital broadcasting transmitter.

In an MPEG2 coding processing, a deterioration in an image is comparatively small and a picture quality can be increased at a comparatively high bit rate (for example, 4 to 6 Mbps in a DVD). However, a time required for picture recording is limited depending on a recording medium. For this reason, it is desirable that coding should be carried out at a comparatively low bit rate (for example, 2 to 3 Mbps in the DVD). In this case, there has generally been employed a method of previously converting a coding object image to have a size of 4/3, ⅔ or ½ by an image size converter (a resolution converter) and carrying out the MPEG2 coding for an image having the same size. However, a resolution of a current image is deteriorated, and furthermore, the coding processing is carried out at a low target bit rate. Consequently, the picture quality is greatly deteriorated so that an increase in the picture quality is hindered.

As a dynamic image coding apparatus corresponding to the MPEG2, Japanese Patent Application Laid-Open No. 2002-16912 has disclosed a dynamic image coding apparatus using a 2-path coding method in which only one coder is used and a scale thereof is reduced. However, this processing carries out multiplexing and separation for data. For this reason, there is a problem in that the processing is complicated.

### SUMMARY OF THE INVENTION

It is an object of the present invention to obtain an image coding apparatus capable of efficiently implementing a 2-path coding processing without increasing hardware (a resource for coding).

A first aspect of the present invention is directed to an image coding apparatus including a dynamic image coder and a coding control section. The dynamic image coder inputs a video signal defining a dynamic image and carries out first and second coding processings for the video signal, to output an output bit stream signal. The coding control section controls a coding operation of the dynamic image coder. In this case, the coding control section controls the dynamic image coder to continuously carry out the first and second coding processings without providing a pause period within a predetermined period.

By using one dynamic image coder, it is possible to prevent an increase in a resource in coding based on the first and second coding processings. In addition, it is possible to efficiently carry out a 2-path coding processing by continuously performing the first and second coding processings without providing the pause period within the predetermined period.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a general image coding apparatus in accordance with MPEG2,

FIGS. 2A to 2D are explanatory diagrams showing various video formats,

FIG. 3 is a block diagram showing a structure of a general 2-path coding apparatus,

FIG. 4 is a block diagram showing a structure of an image coding apparatus according to a first embodiment of the present invention,

FIG. 5 is an explanatory diagram showing contents of an MPEG2 coding operation period assignment in 1-path coding,

FIG. 6 is an explanatory diagram showing the contents of the MPEG2 coding operation period assignment according to the first embodiment,

FIG. 7 is an explanatory diagram showing a memory map of an external DRAM,

FIG. 8 is an explanatory diagram showing a specific example of contents of a 2-path coding processing to be carried out by a coding LSI according to the first embodiment,

FIG. 9 is a flowchart showing a flow of the 2-path coding processing according to the first embodiment,

FIG. 10 is an explanatory diagram showing a 2-path coding sequence to be executed by a coding LSI according to a second embodiment,

FIG. 11 is an explanatory diagram showing a memory map in an SDRAM memory area of an external DRAM according to the second embodiment,

FIG. 12 is an explanatory diagram showing a 2-path coding sequence to be executed by a coding LSI according to a third embodiment,

FIG. 13 is an explanatory diagram showing a memory map in an SDRAM memory area of an external DRAM according to the third embodiment, and

FIG. 14 is a block diagram showing a structure of an image coding apparatus according to a fourth embodiment of the present invention.

### DESCRIPTION OF THE PREFERRED EMBODIMENTS

<Premise Technique>

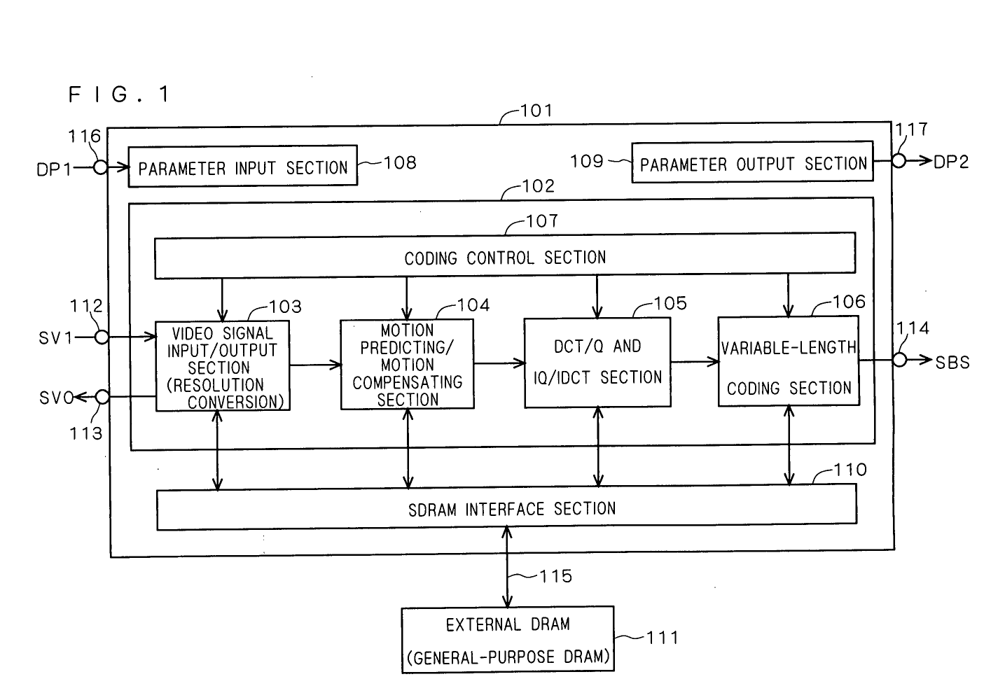

FIG. 1 is a block diagram showing a structure of a general image coding apparatus in accordance with MPEG2 which is a premise technique to understand the present invention.

As shown in FIG. 1, the image coding apparatus is constituted by a coding LSI 101 and an external DRAM 111. The general coding LSI 101 is constituted by an MPEG2 coder 102, a parameter input section 108, a parameter output section 109, an SDRAM interface section 110, a video input terminal 112, a video output terminal 113, a parameter input terminal 116, a parameter output terminal 117 and a bit stream output terminal 114.

The MPEG2 coder 102 is constituted by a coding control section 107, a video signal input/output section 103 to be a signal processing section, a motion predicting/motion compensating section 104, a DCT/Q and IQ/IDCT section 105, and a variable-length coding section 106. These components execute coding while writing and reading data to and from an SDRAM (an external DRAM 111) on a functional block unit (a data unit transmitted and received by each of the components 103 to 106), respectively.

The coding LSI 101 has six kinds of input/output ports (terminals), that is, the video input terminal 112, the video output terminal 113, the bit stream output terminal 114, an SDRAM port 115, the parameter input terminal 116, the parameter output terminal 117, the coding parameter input port 108, the coding parameter output port 109 and the bit stream output port 114. Moreover, an I/O bit width of the external DRAM 111 is substantially supposed to be 16 bits, 32 bits, 64 bits and the like because of restrictions on the number of pins (I/O pins) of an LSI.

A video input signal SV1 input from the video input terminal 112 is subjected to filtering and feature extraction processings by the video signal input/output section 103. The video signal input/output section 103 executes a resolution conversion processing for converting a coding object image size over the video input signal SV1 if necessary.

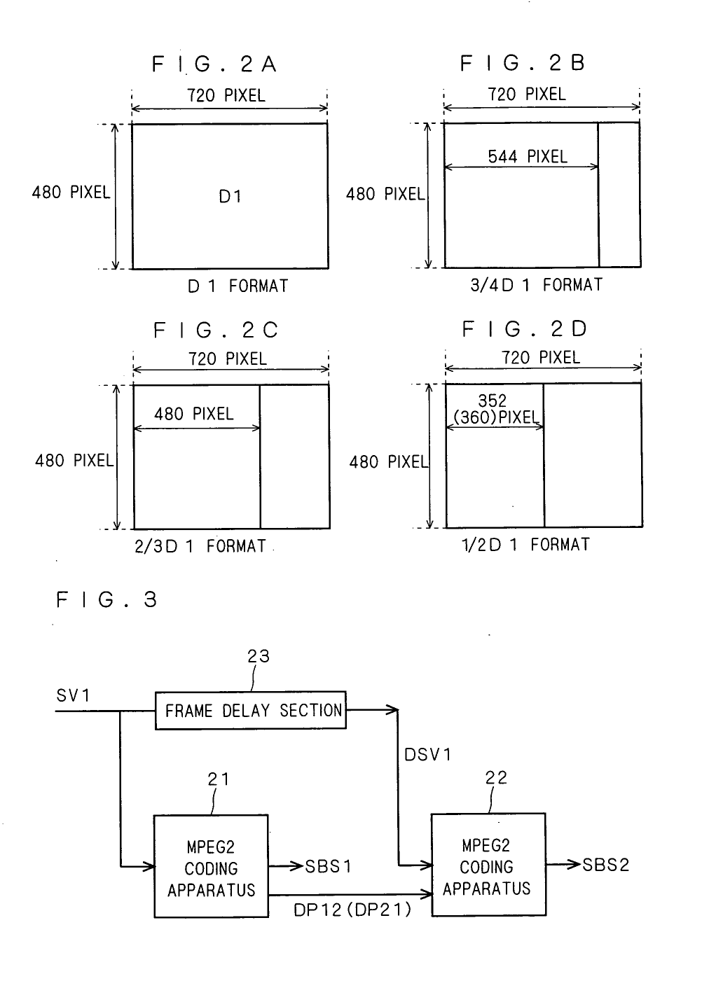

FIGS. 2A to 2D are explanatory diagrams showing various video formats. The resolution conversion processing will be described below with reference to FIGS. 2A to 2D. FIG. 2A shows the most general video format which is obtained when a current television signal (NTSC signal) is digitized, which will be hereinafter referred to as a D1 format. The D1 format has a resolution of 720 pixels×480 lines and is used according to a standard in general digital AV apparatuses (a DVD, an STB (Set Top Box) and a digital video).

On the other hand, a format shown in FIG. 2B is referred to as a ¾ D1 format and is constituted by 544 pixels×480 lines, a format shown in FIG. 2C is referred to as a ⅔ D1 format and is constituted by 480 pixels×480 lines and a format shown in FIG. 2D is referred to as a ½ (half) D1 format and is constituted by 352 (360) pixels×480 lines. For example, in an application intended for a current TV such as a DVD or digital broadcasting, the D1 format is usually used. In the case in which a signal throughput of hardware to be an object is insufficient or coding is carried out at a lower bit rate than usual, the ¾ D1 format, the ⅔ D1 format or the half D1 format is properly used if necessary. For this reason, the MPEG2 coding apparatus is basically provided with a resolution converting circuit.

FIG. 3 is a block diagram showing a structure of a general 2-path coding apparatus. The 2-path coding apparatus shown in FIG. 3 has such a structure that the MPEG2 coding apparatuses 102 illustrated in FIG. 1 are cascade connected in two systems.

With reference to FIG. 3, a conventional 2-path coding method will be briefly described below. An MPEG2 coding apparatus 21 in a first stage inputs a video input signal SV1 to be a coding object and sequentially carries out an MPEG2 coding operation. At this time, various parameter information for the execution of the coding are stored in an optional area of the external DRAM 111. The coding parameter includes motion prediction information about each macro block, macro block type decision information, quantization information, a generated coding amount and the like.

These coding parameter information are output as parameter information DP12 through a parameter output section and are input as parameter information DP21 to a parameter input section of a coder in a second stage. An MPEG2 coding apparatus 22 in the second stage obtains a delay video input signal DSV1 to be a coding object through a flame delay unit 23. More specifically, the MPEG2 coding apparatus 22 inputs the delay video input signal DSV1 subjected to a necessary frame delay by the frame delay section 23 from the video input signal SV1 and sequentially executes MPEG2 coding to transmit a bit stream signal SBS2. At this time, in each coding stage, the parameter information DP21 (DP12) of the MPEG2 coding apparatus 21 in the first stage is input from the parameter input section and determines an optimum coding parameter for the MPEG2 coding apparatus 22 in the second stage with reference to necessary coding parameters (coding parameters obtained by the MPEG2 coding apparatus 21 in the first stage) on units of a picture layer, a slice layer and a macro block layer.

According to the structure described above, the 2-path coding can be implemented in all cases. For this purpose, 2-system (two or more) MPEG2 coding apparatuses and a frame memory for implementing a frame delay are required. In the present invention, there will be described a technique and an image coding apparatus for efficiently implementing 2-path coding by using a 1-system (one) MPEG2 coder.

<First Embodiment>

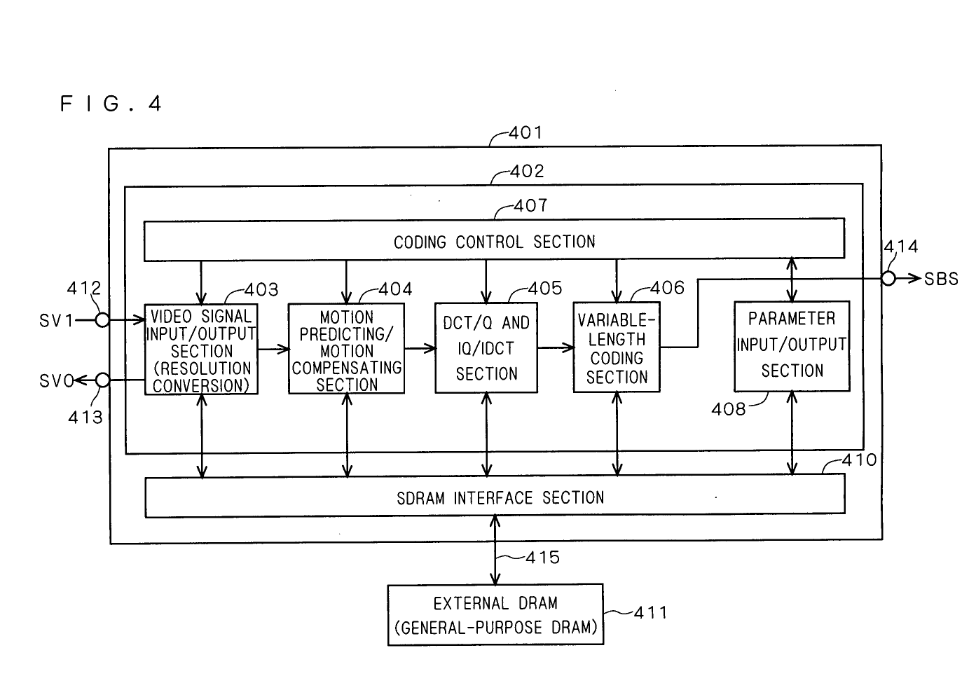

FIG. 4 is a block diagram showing a structure of an image coding processing according to a first embodiment of the present invention. As shown in FIG. 4, the image coding apparatus is constituted by a coding LSI 401 and an external DRAM 411.

The coding LSI 401 is constituted by an MPEG2 coder 402 (a dynamic image coder), an SDRAM interface section 410, a video input terminal 412, a video output terminal 413 and a bit stream output terminal 414.

The MPEG2 coder 402 is constituted by a coding control section 407, a coding parameter input/output section 416 and each signal processing section. The signal processing section is constituted by a video signal input/output section 403, a motion predicting/motion compensating section 404, a DCT/Q and IQ/IDCT section 405, and a variable-length coding section 406, and respective operations are controlled by the coding control section 407 and a parameter input/output section 408 is also controlled by the coding control section 407.

A connecting relationship between the signal processing sections will be described below in detail. The video signal input/output section 403 carries out a signal processing including a resolution conversion processing upon receipt of a video input signal SV1 (a video signal defining a dynamic image) from the video input terminal 412, outputs a video output signal SV0 from the video output terminal 413, and gives a signal processing result to the motion predicting/motion compensating section 404.

The motion predicting/motion compensating section 404 carries out a motion prediction and a motion compensation based on the signal processing result of the video signal input/output section 403, and gives the signal processing result to the DCT/Q and IQ/IDCT section 405.

The DCT/Q and IQ/IDCT section 405 carries out a discrete cosine transform (DCT) processing and a quantization processing (Q) for the signal processing result of the motion predicting/motion compensating section 404 to obtain a signal processing result. In this case, an inverse discrete cosine processing (IDCT) and an inverse quantization processing (IQ) for feeding back the signal processing result are also carried out.

The variable-length coding section 406 carries out a variable-length coding processing for the signal processing result of the DCT/Q and IQ/IDCT section 405 and outputs a bit stream signal SBS from the bit stream output terminal 414.

The parameter input/output section 408 can input/output a coding parameter stored in the external DRAM 411, and can give the coding parameter through the coding control section 407 to the MPEG2 coder 402, the video signal input/output section 403, the motion predicting/motion compensating section 404, and the DCT/Q and IQ/IDCT section 405.

Each of the components 403 to 406 executes the coding while writing and reading data to and from the external DRAM 411 (storage section) on a functional block unit.

The coding LSI 401 has four kinds of input/output ports (terminals), that is, the video input terminal 412, the video output terminal 413, the SDRAM port 415 and the bit stream output port 414. Moreover, an I/O bit width of the external DRAM 411 is substantially supposed to be 16 bits, 32 bits, 64 bits and the like because of restrictions on the number of pins (I/O pins) of an LSI.

It is assumed that the MPEG2 coder has such a capability as to process 30 current TV images, that is, D1 format videos in one second (MP ML in an MPEG2 standard). The throughput itself is equivalent to that of the conventional MPEG2 coder shown in FIG. 1. Moreover, a coding parameter input terminal and a coding parameter output terminal are not assigned as external pins for the following reason. More specifically, it is basically assumed that a coding operation which does not need to input a coding parameter from an outside or to output the coding parameter to the outside is carried out.

The coding operation will be described with reference to FIG. 4. The input video input signal SV1 (NTSC signal) carries out the MPEG2 coding operation on a frame unit in accordance with the following sequence. A digitized video input signal (ex. an ITU-R-656 format) is first input to the video signal input/output section 403. Then, a signal processing result is written to an original picture area on the external DRAM 411. In FIG. 4, a compressing operation is executed on a macro block unit in order of DCT, quantization (Q) and variable-length coding. Then, an original picture bit stream is properly subjected to reordering (a processing of changing order of an image to be coded) and the coding is thereafter carried out in a picture type referred to as an I picture, a P picture or a B picture.

Description will be given to a coding sequence in the P picture or the B picture requiring all data transfer operations. A template image for retrieving a motion is read through the external DRAM 411 and a coding object image is read from the external DRAM 411.

Data on the external DRAM 411 are transferred to the motion predicting/motion compensating section 404 and the DCT/Q and IQ/IDCT section 405, respectively. In the motion predicting/motion compensating section 404, moreover, a bit stream in a necessary area for a search window in a reconfiguration image bit stream area prewritten simultaneously is transferred from the external DRAM 411 so that search window data can be obtained.

Then, a prediction image is generated in accordance with an optimum motion vector obtained by the motion predicting/motion compensating section 404 and DCT and Q (quantization) processings are executed by the DCT/Q and IQ/IDCT section 405, and a variable-length coding processing is then carried out by the variable-length coding section 406. Finally, a bit stream signal SBS (an output bit stream signal) is transmitted from the bit stream output terminal 414. In the coding operation, an operation for coding the bit stream is executed in accordance with a picture sequence. This operation is collected in the following sequence of \mathring{1} to \mathring{8}.

\mathring{1} Fetch original image data (a video input/output (input the video input signal SV1 and output the video output signal SV0)→an external frame memory (the external DRAM 111))

\mathring{2} Read a coding object image (an external frame memory→a DCT/Q unit) (the DCT/Q and IQ/IDCT section 405)

\mathring{3} Search a motion (retrieve integer precision) (search precision of one pixel) (an external frame memory→a motion predicting/compensating unit (the motion predicting/motion compensating section 404))

\mathring{4} Search a motion (half pel (search with high precision of a ½ pixel)) (an external frame memory →a motion predicting/compensating unit)

\mathring{5} Generate a prediction image (an image on a macro block unit specified by a motion vector) (an external frame memory →a motion predicting/compensating unit)

\mathring{6} Write a reconfiguration image (an image on a macro block unit regenerated based on the prediction image) (a motion predicting/compensating unit an external frame memory)

\mathring{7} Write and read coding data (a variable-length coding unit (the variable-length coding section 406←→an external frame memory)

\mathring{8} Decoded image (an image for one screen of a reconfiguration image) (an external frame memory →a video input/output)

In the original image data fetching processing \mathring{1}, an original image is stored in a form obtained by executing a resolution conversion to carry out a conversion from the D1 format into the ¾, ⅔ or half D1 format depending on a property of a video signal. From the processing \mathring{2} and succeeding processings, a substantial MPEG2 coding operation is started. By two kinds of searching operations \mathring{3} and \mathring{4}, it is possible to obtain a motion vector rapidly (a comparatively high-speed search by the search \mathring{3}) with high precision (a search with comparatively high precision by the search \mathring{4}). Moreover, the prediction image is based on the motion vector obtained by the motion predicting/compensating unit. The reconfiguration image is obtained by carrying out inverse quantization (IQ) and inverse DCT transform over the prediction image. The coding data are obtained by coding a signal sent from the DCT/Q unit by means of the variable-length coding unit.

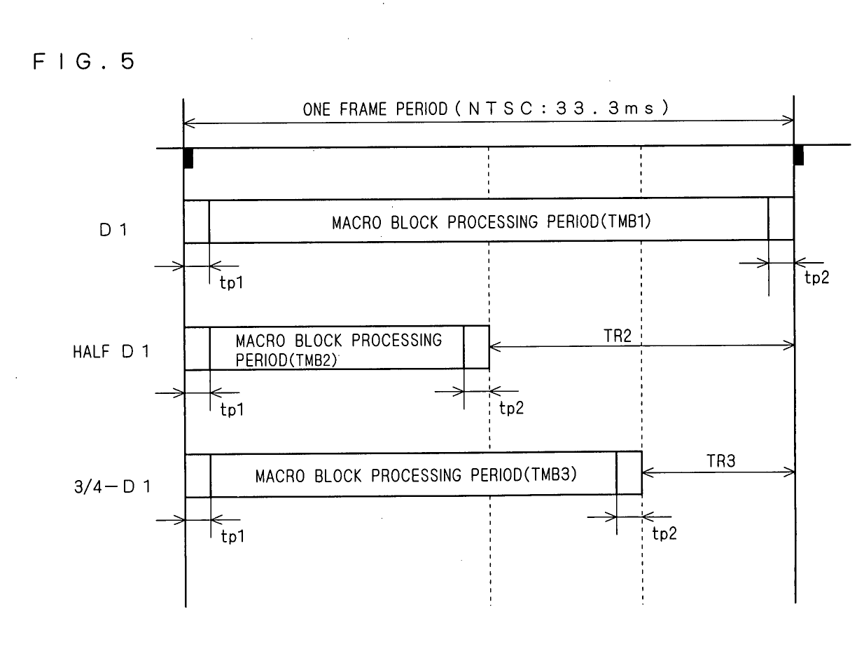

FIG. 5 is an explanatory diagram showing contents of an MPEG2 coding operation period assignment in path coding. As shown in FIG. 5, it is necessary to assign a picture preprocessing period tp1, a picture postprocessing period tp2 and a macro block processing period TMB into one frame period (33.3 ms in NTSC). A black-colored portion shown in a first part of the frame period implies a frame synchronization pulse.

In the case in which a video signal in the D1 format is to be coded, almost whole one frame period is assigned to a macro block processing period TMB1 to be a coding processing period. At time of start of a frame processing, a whole processing (a picture preprocessing) for determining a coding parameter related to a whole frame, for example, determining a picture type of the frame and determining a target bit amount (a target compression bit amount) and for initializing each hardware is carried out. A period required for the picture preprocessing is the picture preprocessing period tp1.

Then, the coding operations \mathring{2} to \mathring{8} are carried out on a macro block unit for the macro block processing period TMB1.

When the macro block processing period TMB1 is ended, a necessary postprocessing (picture postprocessing) in the frame, for example, calculation of an amount of generated bits or the like is carried out and the coding operation in the frame (picture) is completed. A period required for the picture postprocessing is the picture postprocessing period tp2.

The picture preprocessing period tp1 and the picture postprocessing period tp2 are several tensμ sec respectively and most of the time is assigned to the macro block processing period TMB1.

Referring to FIG. 5, description will be given to a coding object image in the half D1 format, for example. In the half D1 format, an object image size is a half of that in the D1 format. Therefore, the number of micro blocks to be processed is also halved. More specifically, the D1 format has 1350 MB (macro blocks) per frame, while the half D1 has 660 MB per frame. For a macro block processing period TMB2 in the half D1 format coding, therefore, the coding operation is ended in almost a half of a time required for the macro block processing period TMB1 in the D1 format coding as shown in FIG. 5 and a residual period is set to be a processing pause period TR2. Also in the coding operation in a ¾ D1 format, similarly, approximately ¾ of the frame period is used and residual ¼ is set to be a pause period TR3.

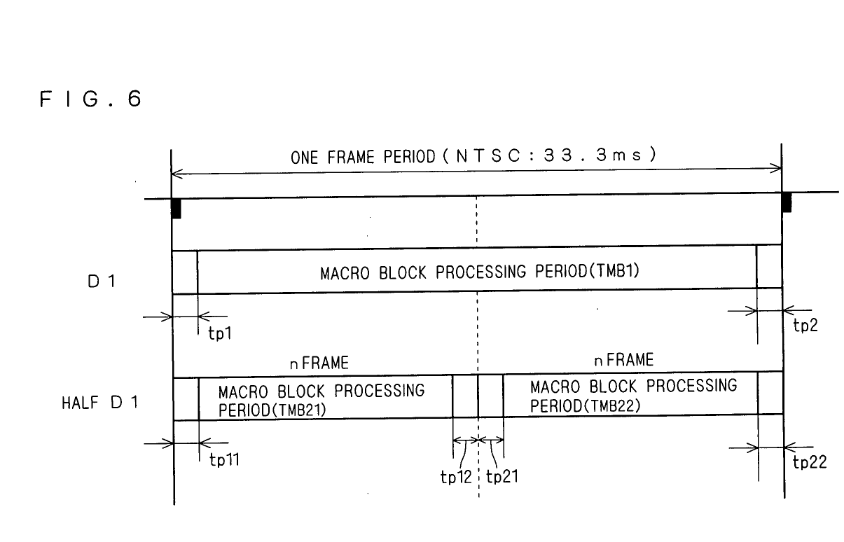

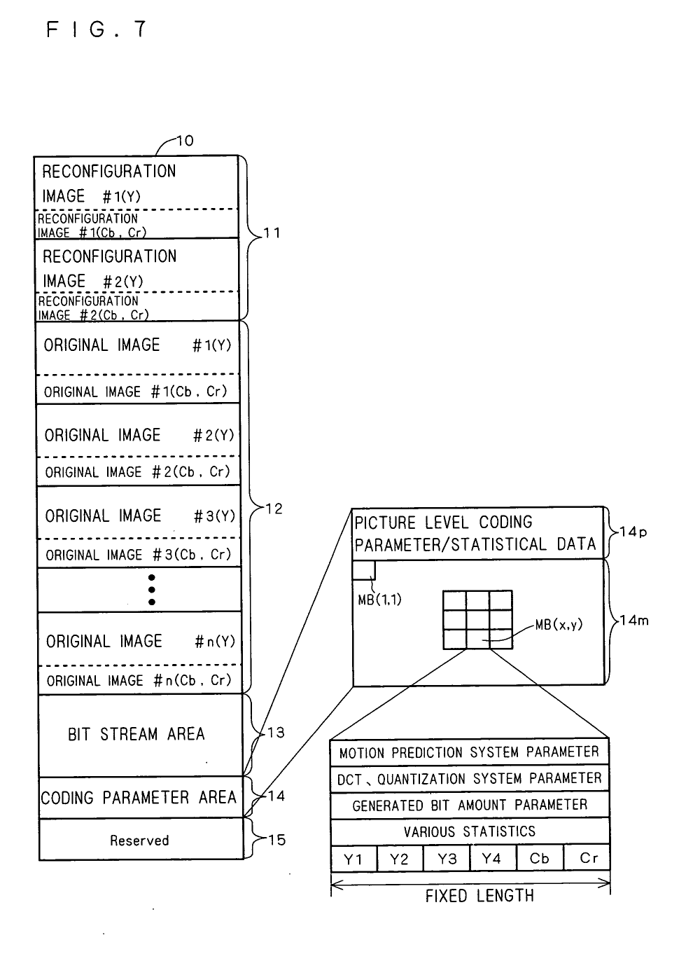

FIG. 6 is an explanatory diagram showing contents of an MPEG2 coding operation period assignment to be carried out by a coding LSI according to the first embodiment of the present invention.

With reference to FIG. 6, a coding operation according to the first embodiment will be described below. In the case in which a resolution conversion is executed by the video signal input/output section 403, the coding operation is carried out, that is, first and second coding processings are continuously carried out without providing a pause period for two frames (intended for the same frame (an nth frame) in the first embodiment) within one frame period (a predetermined period) by utilizing the pause period (TR2, TR3) in FIG. 5 and a 2-path coding operation is thus implemented equivalently.

In FIG. 6, a period assignment to be carried out when coding a video (frame) in the half D1 format is shown. As shown in FIG. 6, macro block processing periods TMB21 and TMB22 to be periods for a 2-path coding processing in the half D1 format are provided for one frame and the 2-path coding processing in the half D1 format is executed within one fame. Picture preprocessing periods tp11 and tp2l are provided before the macro block processing periods TMB21 and TMB22, and picture postprocessing periods tp12 and tp22 are provided after the macro block processing periods TMB21 and TMB22.

When coding in an nth frame (the half D1 format) is to be carried out, the MPEG2 coding operation is once executed for a first half period (the macro block processing period TMB21). At this time, various coding parameters generated in the coding (see the following) are stored in a coding parameter area of the external DRAM 411 through the SDRAM interface section 410 by the parameter input/output section 408 in FIG. 4. In the present embodiment, the coding parameters are classified into a picture level and a macro block level (to which a storage area is assigned for each macro block) and are thus stored. Since a bit stream generated at this time is not directly used (but is used for only the coding parameter in the coding), it does not need to be stored in the external DRAM 411. For example, the coding parameters are as follows. (In the case in which the coding parameter has the picture level)

a picture type,

a target bit,

an amount of generated codes

a mean quantization step,

an f code (indicating a motion vector range), and

other statistics (a mean value, a distribution value and the like of a pixel).

(In the case in which the coding parameter has the macro block level)

a motion vector candidate and an evaluation value thereof,

a quantization step,

a macro block type and a parameter value used for a decision

an amount of generated codes, and

other parameters.

As shown in FIG. 6, when the operation for coding an image in the half D1 format is once ended within a first half period of the frame, a second half coding operation is then started. The coding parameters obtained by the first half coding operation are sequentially read from the external DRAM 411 through the parameter input/output section 408 and necessary information is applied by referring to the same coding parameters as coding parameters for executing the coding operation. At this time, places for storing the coding parameters having the picture level and the macro block level are known in advance. Therefore, the parameter input/output section 408 can be obtained by reading required information from the external DRAM 411 if necessary.

FIG. 7 is an explanatory diagram showing a memory map of the external DRAM 411. As shown in FIG. 7, an original image area 12 corresponding to delay frames (n frames) for reorder and 2-path coding, a reconfiguration image area 11 (corresponding to 2 frames) for the coding, a bit stream area 13, a coding parameter area 14 and a reserved area 15 are mapped into an SDRAM memory area 10.

As shown in FIG. 7, the coding parameter area 14 is further divided into a picture area 14p and a macro block area 14m, and the macro block area 14m is mapped two-dimensionally (L×M). A parameter group comprising a motion prediction system parameter, DCT, a quantization system parameter, a generated bit amount parameter, various statistics, and luminance signal (Y1 to Y4) and color difference signal (Cb, Cr) system parameters are stored in the macro block unit parameter MB (x (any of 1 to L), y (any of 1 to M)) mapped two-dimensionally, respectively. The parameters of the parameter group are arranged to have a fixed length on a macro block unit.

Thus, the macro block area 14m has the macro block unit parameters arranged two-dimensionally. Consequently, it is possible to obtain an advantage that an address can easily be generated for acquiring a parameter on the macro block unit.

In the coding operation at a second stage, therefore, it is possible to randomly fetch a coding parameter in any area. More specifically, if the parameter on the macro block unit is stored in the macro block area 14m in the SDRAM memory area 10 as shown in FIG. 7, two-dimensional addressing can easily be carried out on the macro block unit. In the case in which reference is to be made vertically and transversely over a macro block in which a motion prediction related parameter group is a coding object, particularly, the parameter can easily be extracted.

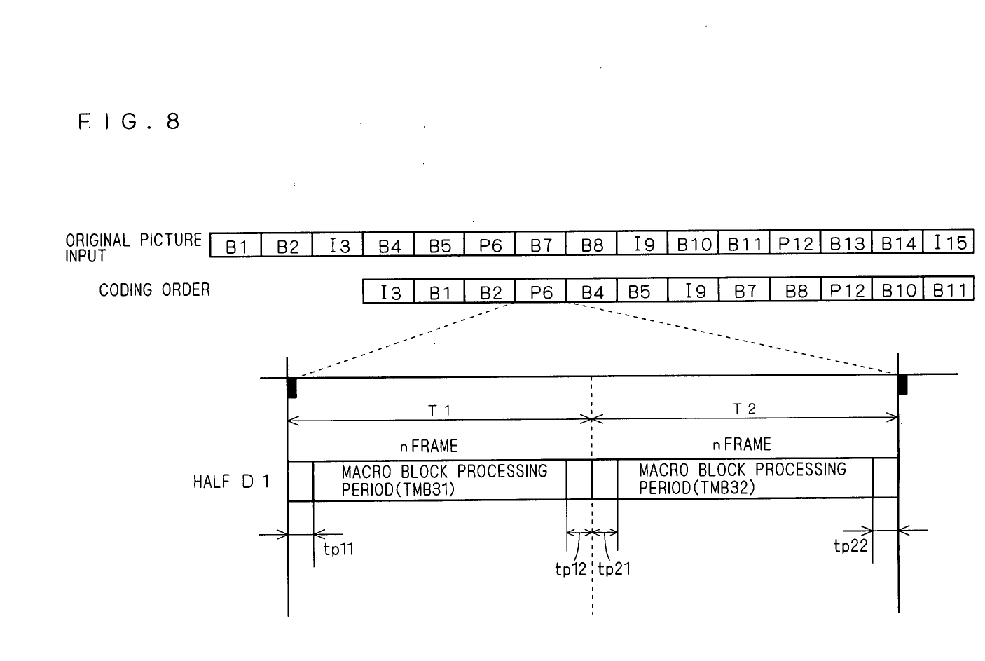

FIG. 8 is an explanatory diagram showing a specific example of the contents of the 2-path coding processing for a signal in the half D1 format which is to be carried out by the coding LSI according to the first embodiment.

FIG. 8 shows an example in which when an original picture input is carried out in order of B1, B2, I3, B4, B5, P6, B7, B8, I9, B10, B11, P12, B13, B14 and I15 (I, P and B are I, P and B pictures, respectively), coding for the “P6” is carried out in two paths in the case in which coding order is I3, B1, B2, P6, B4, B5, I9, B7, B8, P12, B10, B11, . . . .

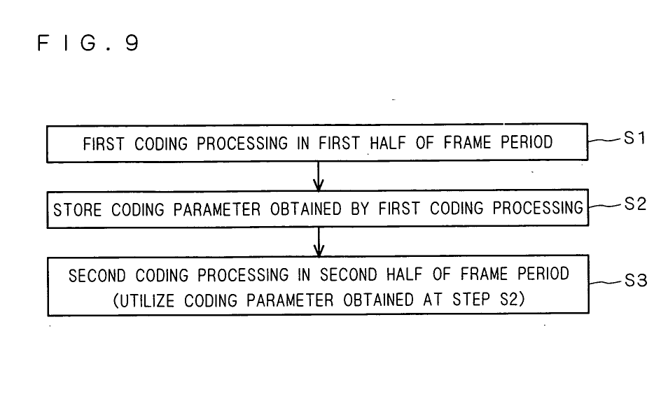

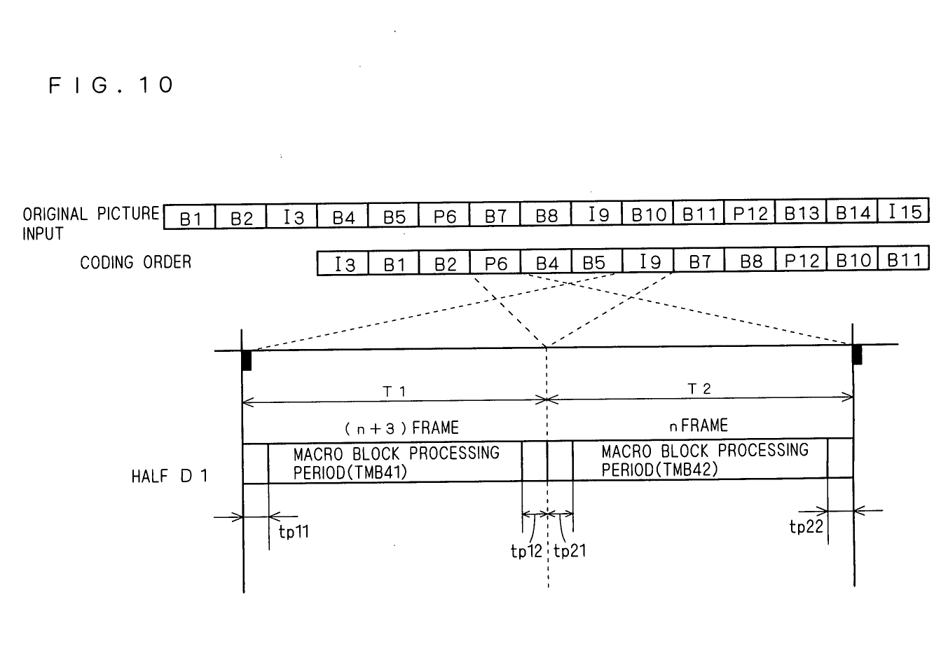

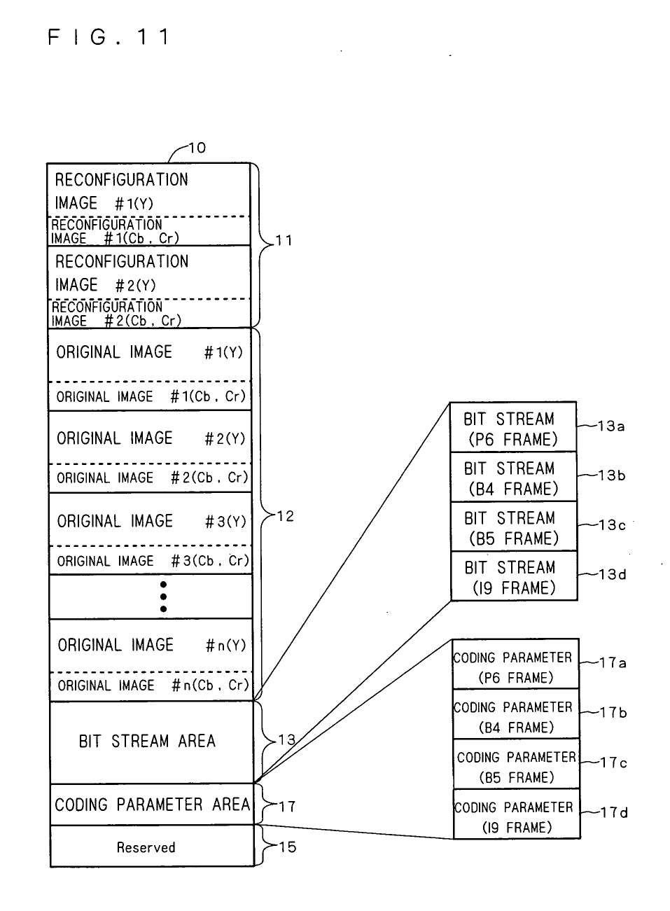

FIG. 9 is a flowchart showing a flow of the 2-path coding processing for the video signal in the half D1 format which is to be carried out under control of the coding control section 407 according to the first embodiment. The 2-path coding processing according to the first embodiment based on the example of FIG. 8 will be described below with reference to FIG. 9.

First of all, a first coding processing of the MPEG2 coder 402 is executed in a first half of the frame period at a step S1.

For a period T1 in FIG. 8 corresponding to the first half of the frame period, a period is set in order of a picture preprocessing period tp11, a macro block processing period TMB31 and a picture postprocessing period tp12. For the macro block processing period TMB31, the first coding processing for generating a coding parameter is carried out for the “P6”.

Next, a coding parameter (information for a coding processing) obtained by the first coding processing is stored in the external DRAM 411 at a step S2. More specifically, the coding parameter is transferred from the video signal input/output section 403, the motion predicting/motion compensating section 404, the DCT/Q and IQ/IDCT section 405 and the variable-length coding section 406 to the parameter input/output section 408 through the coding control section 407, and the parameter input/output section 408 stores the coding parameter in the external DRAM 411 through the SDRAM interface section 410. In this case, the coding parameter obtained by the first coding processing is stored in the SDRAM memory area 10 of the external DRAM 411 as shown in FIG. 7.

Then, a second coding processing of the MPEG2 coder 402 is executed in a second half of the frame period. In this case, the coding parameter obtained at the step S2 is utilized.

For a period T2 in FIG. 8 corresponding to a second half of the frame period, a period is set in order of a picture preprocessing period tp21, a macro block processing period TMB32 and a picture postprocessing period tp22. For the macro block processing period TMB32, the second coding processing for generating a bit stream signal SBS is carried out for the “P6”.

In this case, the coding parameter obtained by the first coding processing is read from the SDRAM memory area 10 of the external DRAM 411 and the second coding processing is executed by using the coding parameter. Consequently, it is possible to obtain the bit stream signal SBS which is coded more efficiently.

The coding parameter stored in the external DRAM 411 is transferred to the parameter input/output section 408 through the external DRAM 411. The parameter input/output section 408 gives the acquired coding parameter to the video signal input/output section 403, the motion predicting/motion compensating section 404, the DCT/Q and IQ/IDCT section 405 and the variable-length coding section 406 through the coding control section 407.

Thus, the coding LSI 401 according to the first embodiment can carry out a coding processing based on the 2-path coding processing for one frame period over the “P6” of the same frame (the nth frame) in the half D1 format.

Accordingly, both of the first and second coding processings are executed by using the same MPEG2 coder 402. Therefore, it is not necessary to increase a resource for the coding in the first and second coding processings. In addition, the first and second coding processings are continuously carried out without providing a pause period within one frame period. Consequently, the 2-path coding processing can efficiently be carried out.

Moreover, the 2-path coding processing for the same frame is executed. Consequently, the coding for one frame can completely be executed for one frame period.

In the specific example shown in FIG. 8, there has been described the 2-path coding to be carried out when the resolution conversion in the half D1 is performed. Referring to the ¾ D1 and ⅔ D1 formats, in an MPEG2 coder having a coding throughput having a current TV size according to the conventional art, the 2-path coding method described above has an insufficient throughput, and the throughput should be 1.5 times as much as that of the current (MP, ML) MPEG2 coder (a double of ¾) when the 2-path coding in the ¾ D1 format is to be executed and should be 1.33 times as much as that of the current (MP, ML) MPEG2 coder (a double of ⅔) when the 2-path coding in the ⅔ D1 format is to be executed. It is possible to obtain an advantage that the 2-path coding can be implemented for a shorter processing period than that in the case in which 2-system MPEG2 coders are simply connected in series in a general way (FIG. 3).

<Second Embodiment>

In the structure and coding operation according to the first embodiment, there has been described the case in which the coding operation (the first coding processing) and the actual coding (the second coding processing) for obtaining a 2-path coding parameter are intended for the same frame.

In a second embodiment, processings intended for different frames are executed between the first coding processing and the second coding processing for obtaining a 2-path coding parameter.

FIG. 10 is an explanatory diagram showing a 2-path coding sequence to be executed by a coding LSI according to the second embodiment.

FIG. 10 shows an example in which when an original picture input is carried out in order of B1, B2, I3, B4, B5, P6, B7, B8, I9, B10, B11, P12, B13, B14 and I15, coding for the “I9” and the “P6” is carried out in two paths in the case in which coding order is I3, B1, B2, P6, B4, B5, I9, B7, B8, P12, B10, B11, . . . .

For a period T1 in which coding in a first stage is to be carried out, a period is set in order of a picture preprocessing period tp11, a macro block processing period TMB41 and a picture postprocessing period tp12. For the macro block processing period TMB41, the first coding processing for generating a coding parameter is carried out for the “I9”. The coding parameter obtained by the first coding processing is stored in an SDRAM memory area 10 of an external DRAM 411.

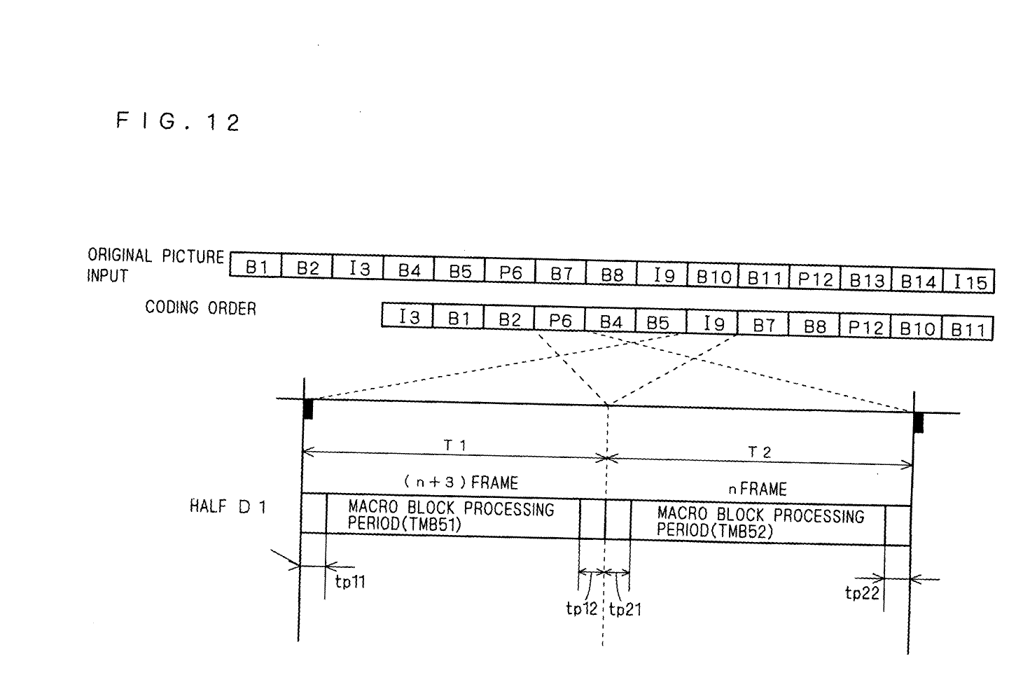

FIG. 11 is an explanatory diagram showing a memory map in the SDRAM memory area 10 of the external DRAM 411 according to the second embodiment. As shown in FIG. 11, a coding parameter area 17 is divided into partial coding parameter areas 17a to 17d. A bit stream area 13 is constituted by partial bit stream areas 13a to 13d corresponding to four frames, which is not shown in FIG. 7.

When the coding parameter is generated for the “I9”, a coding parameter for the “P6” obtained by the first coding processing is stored in the partial coding parameter area 17a, a coding parameter for the “B4” obtained by the first coding processing is stored in the partial coding parameter area 17b, and a coding parameter for the “B5” obtained by the first coding processing has already been stored in the partial coding parameter area 17c. The newest coding parameter for the “19” obtained by the first coding processing is stored in the partial coding parameter area 17d.

More specifically, in the second embodiment, the coding parameters obtained by the first coding processing for three succeeding frames (an (n +1)th frame to an (n +3)th frame) as well as the actual coding object frame (an nth frame) are utilized for the same frame (the nth frame).

For a period T2 in which coding in a second stage is to be carried out, a period is set in order of a picture preprocessing period tp21, a macro block processing period TMB42 and a picture postprocessing period tp22. For the macro block processing period TMB42, the second coding processing for generating a bit stream signal is carried out for the “P6”. In this case, there are used the coding parameters corresponding to four frames (P6, B4, B5 and I9) obtained by the first coding processing which are stored in the coding parameter area 17.

In the second embodiment, thus, the first and second coding processing for different frames are executed. Consequently, the coding can be carried out more efficiently. More specifically, the coding processing based on the 2-path coding processing utilizing the coding parameters corresponding to the four frames for the “P6” of a frame in a half D1 format is carried out for one frame period. Consequently, the coding can efficiently be carried out.

In the second embodiment, accordingly, coding control can be carried out more efficiently so that a picture quality can be enhanced. Moreover, all the coding parameters corresponding to the four frames do not need to be applied but may be utilized properly and selectively if necessary.

<Third Embodiment>

In the first embodiment, there has been described the case in which the coding operation in the first half of the frame is carried out for extracting the coding parameter and the bit stream output therefrom is not used.

In a third embodiment, a bit stream signal SBS obtained by a first coding processing is stored in an external DRAM 411 and is utilized again. In the third embodiment, moreover, processings intended for different frames are executed between the first coding processing and a second coding processing for obtaining a 2-path coding parameter in the same manner as in the second embodiment.

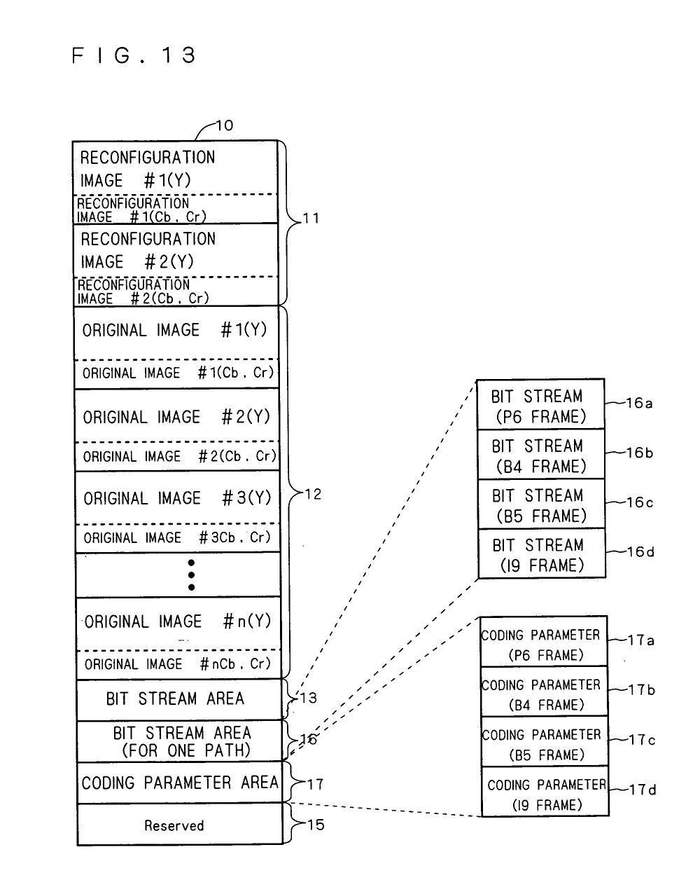

FIG. 12 is an explanatory diagram showing a 2-path coding sequence to be executed by a coding LSI according to the third embodiment.

FIG. 12 shows an example in which when an original picture input is carried out in order of B1, B2, I3, B4, B5, P6, B7, B8, I9, B10, B11, P12, B13, B14 and I15, coding for the “P6” is carried out in two paths in the case in which coding order is I3, B1, B2, P6, B4, B5, I9, B7, B8, P12, B10, B11, . . . .

For a period T1 in which coding in a first stage is to be carried out, a period is set in order of a picture preprocessing period tp11, a macro block processing period TMB51 and a picture postprocessing period tp12. For the macro block processing period TMB51, the first coding processing for generating a coding parameter and a bit stream signal is carried out for the “I9”. A first bit stream signal obtained by the first coding processing is stored in a bit stream area 16 of an SDRAM memory area 10 of an external DRAM 411.

There has also been stored, in the SDRAM memory area 10, a first bit stream signal obtained by the first coding processing for last three frames (an nth frame to an (n+2) th frame) which has already been carried out.

In the same manner as in the second embodiment, moreover, the coding parameters obtained by the first coding processing for three succeeding frames (an (n+1)th frame to an (n+3)th frame) as well as the actual coding object frame (the nth frame) are also stored in the SDRAM memory area 10 for the same frame (the nth frame).

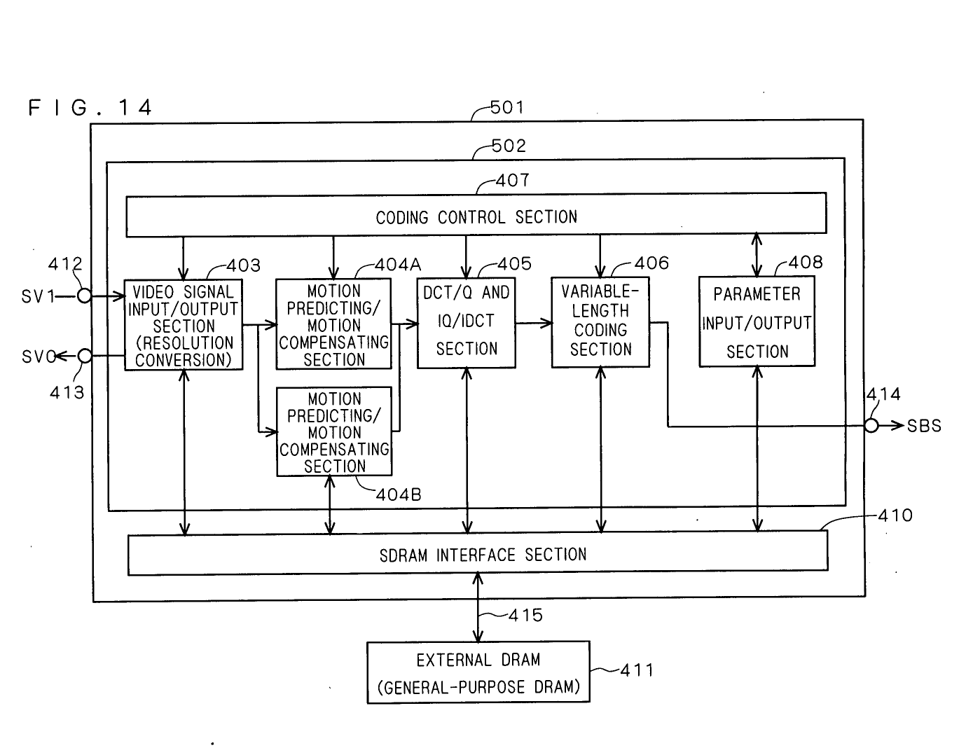

FIG. 13 is an explanatory diagram showing a memory map in the SDRAM memory area 10 of the external DRAM 411 according to the third embodiment. As shown in FIG. 13, a bit stream area 16 for one path is provided in addition to a bit stream area 13. A bit stream signal obtained by the first coding processing is stored in the bit stream area 16 for one path. The bit stream area 16 is also constituted by partial bit stream areas 16a to 16d corresponding to four frames in the same manner as the bit stream area 13.

For a period T2 in which coding in a second stage is to be carried out, a period is set in order of a picture preprocessing period tp21, a macro block processing period TMB52 and a picture postprocessing period tp22. For the macro block processing period TMB52, the second coding processing for generating a second bit stream signal is carried out for the “P6”. In this case, coding parameters corresponding to four frames (P6, B4, B5 and I9) obtained by the first coding processing which are stored in a coding parameter area 17 are used in the same manner as in the second embodiment.

Total bit amounts and the like are compared between the first bit stream signal (stored in the bit stream area 16) and the second bit stream signal (stored in the bit stream area 13) corresponding to the frame “P6” stored in the bit stream area 16 for one path. Either of the first and second bit stream signals which is decided to be coded in an efficient state can be sent as a bit stream signal SBS (an output bit stream signal) which is actually output from a bit stream output terminal 414.

In the third embodiment, thus, the first and second coding processings for different frames are sequentially carried out, and at the same time, the bit stream signal SBS is selectively determined from the first and second bit stream signals corresponding to the same frame. Consequently, it is possible to send the bit stream signal SBS in such a state that the coding can be carried out more efficiently.

<Fourth Embodiment>

FIG. 14 is a block diagram showing a structure of an image coding apparatus according to a fourth embodiment of the present invention. As shown in FIG. 14, the image coding apparatus is constituted by a coding LSI 501 and an external DRAM 411. An MPEG2 coder 502 in the coding LSI 501 has two kinds of motion predicting/motion compensating sections 404A and 404B (first and second partial coding sections) which carry out a similar motion prediction/motion compensation and have different contents.

The motion predicting/motion compensating sections 404A and 404B are controlled by a coding control section 407, and the motion predicting/motion compensating section 404A is used in a first coding processing and the motion predicting/motion compensating section 404B is used in a second coding processing. The motion predicting/motion compensating section 404A carries out a motion prediction processing (a first partial coding processing) having a wide range and a low density, and the motion predicting/motion compensating section 404B carries out a motion prediction processing (a second partial coding processing) which has a narrow range and a high density. Since other structures are the same as those of the coding LSI 401 shown in FIG. 4, the same portions as those in FIG. 4 have the same reference numerals and description thereof will be omitted.

With reference to FIG. 8 used in the first embodiment, description will be given to a 2-path coding processing to be carried out by the coding LSI 501 according to the fourth embodiment.

For a period T1 in which coding in a first stage is to be carried out, a period is set in order of a picture preprocessing period tp11, a macro block processing period TMB31 and a picture postprocessing period tp12. For the macro block processing period TMB31, the first coding processing using the motion predicting/motion compensating section 404A is carried out for the “P6”.

The first coding processing is mainly carried out for generating a coding parameter for a motion compensation, and the coding parameter obtained by the first coding processing is stored in the coding parameter area 17 of the SDRAM memory area 10 in the external DRAM 411 as shown in FIG. 7.

For a period T2 in which coding in a second stage is to be carried out, a period is set in order of a picture preprocessing period tp21, a macro block processing period TMB32 and a picture postprocessing period tp22. For the macro block processing period TMB32, the second coding processing using the motion predicting/motion compensating section 404B is carried out for the “P6”.

In the second coding processing, it is possible to narrow a search range by using the coding parameter obtained by the first coding processing. Consequently, it is possible to carry out a motion compensation by a search at a high density (with high precision) using the motion predicting/motion compensating section 404B without adversely influencing a processing time.

By carrying out the first and second coding processings by means of the different motion predicting/motion compensating sections 404A and 404B, thus, it is possible to carry out a motion prediction/motion compensation which is more suitable for the first and second coding processings.

While the first and second coding processings for the same frame have been carried out in the same manner as the contents of the processings according to the first embodiment, it is also possible to employ such a structure that the first and second coding processings for different frames are carried out in the same manner as the contents of the processings according to the second and third embodiments. In short, it is preferable that the motion predicting/motion compensating section 404A should be used in the first coding processing and the motion predicting/motion compensating section 404B should be used in the second coding processing.

While there has been described the example in which plural kinds of motion predicting/motion compensating sections are provided as arithmetic units (partial coding sections), plural kinds of arithmetic units (a video input/output section, a DCT/Q and IQ/IDCT section, a variable-length coding section or a parameter input/output section) may be provided to use different kinds of arithmetic units between the first and second coding processings.

More specifically, it is possible to implement effective 2-path coding by providing plural kinds of effective arithmetic units in the 2-path coding. Moreover, it is also possible to have such a structure as to properly select either of the arithmetic units to be used in the coding operations for first and second paths by means of a switch. Thus, flexible coding can be implemented.

While the invention has been shown and described in detail, the foregoing description is in all aspects illustrative and not restrictive. It is therefore understood that numerous modifications and variations can be devised without departing from the scope of the invention.

What is claimed is:

1. An image coding apparatus comprising:
a dynamic image coder for inputting a video signal defining a dynamic image and carrying out first and second coding processings for said video signal, to output an output bit stream signal; and
a coding control section for controlling a coding operation of said dynamic image coder,
wherein said coding control section controls said dynamic image coder to continuously carry out said first and second coding processings without providing a pause period within a predetermined period.

2. The image coding apparatus according to claim 1, further comprising:
a storage section connected to said dynamic image coder, wherein
said dynamic image coder stores, in said storage section, information for a coding processing which is obtained by said first coding processing and executing said second coding processing by using said information for a coding processing which is obtained from said storage section, to output said output bit stream signal.

3. The image coding apparatus according to claim 2, wherein
said dynamic image coder includes first and second partial coding sections for executing first and second partial coding processings which are similar and have different contents,
said first coding processing includes said first partial coding processing to be carried out by said first partial coding section, and
said second coding processing includes said second partial coding processing to be carried out by said second partial coding section.

4. The image coding apparatus according to claim 2, wherein
said information for a coding processing includes a coding parameter defining various parameters which are necessary for said second coding processing.

5. The image coding apparatus according to claim 1, further comprising:
a storage section connected to said dynamic image coder, wherein
said dynamic image coder stores, in said storage section, a first bit stream signal obtained by said first coding processing and executes said second coding processing to obtain a second bit stream signal, to output one bit stream signal as said output bit stream signal based on a result of a comparison of said second bit stream signal with said first bit stream signal obtained from said storage section.

6. The image coding apparatus according to claim 1, wherein
said first and second coding processings are carried out for a video signal corresponding to the same frame.

7. The image coding apparatus according to claim 1, wherein
said first and second coding processings are carried out for video signals corresponding to different frames.

8. The image coding apparatus according to claim 2, wherein
said storage section stores said information for a coding processing on a macro block unit two-dimensionally.
